(19) United States
(12) Patent Application Publication
(10) Pub. No.: US 2008/0278674 A1
(43) Pub. Date: Nov. 13, 2008

(54) METHOD FOR FABRICATING REFLECTIVE OPTICAL FILM AND REFLECTIVE POLARIZING FILM AND METHOD FOR FABRICATING THE SAME

(75) Inventors: Yue-Shih Jeng, Miaoli County (TW); Yu-Hsun Wu, Taoyuan County (TW); Yen-Shih Lin, Taichung County (TW)

Correspondence Address: J C PATENTS, INC., 4 VENTURE, SUITE 250, IRVINE, CA, 92618, US

(73) Assignees: TAIWAN TFT LCD ASSOCIATION, Hsinchu (TW); CHUNGHWA PICTURE TUBES, LTD., Taipei (TW); AU OPTRONICS CORPORATION, Hsinchu (TW); HANNSTAR DISPLAY CORPORATION, Tao-Yuan Hsien (TW); CHI MEI OPTOELECTRONICS CORPORATION, Tainan County (TW); INDUSTRIAL TECHNOLOGY RESEARCH INSTITUTE, Hsinchu (TW); TPO DISPLAYS CORP., Miao-Li County (TW)

(21) Appl. No.: 11/851,919

(22) Filed: Sep. 7, 2007

(30) Foreign Application Priority Data
May 8, 2007 (TW) 96116277

(51) Int. Cl. G02B 5/30; B05D 5/06; G02B 1/02

(52) U.S. Cl. 349/194; 427/163.1

(57) ABSTRACT

A method for fabricating a reflective optical film is provided. A substrate is first provided. Next, a phase retardation film is formed on at least one side of the substrate by means of coating. Afterward, a cholesteric liquid crystal (CLC) layer is formed on the phase retardation film by means of coating. Hence, the conventional external bond fabrication process can be simplified. Further, the undesired optical results caused by the more disordered alignment in the upper layer of CLC being more disordered compared to that in the lower layer of CLC and the failure to display the compensation effect can be overcome.

### CROSS-REFERENCE TO RELATED APPLICATION

This application claims the priority benefit of Taiwan application serial no.96116277, filed on May 8, 2007. All disclosure of the Taiwan application is incorporated herein by reference.

### BACKGROUND OF THE INVENTION

1. Field of the Invention

The present invention relates to a fabrication method of a reflective optical film, and a reflective polarizing film and a fabrication method thereof.

2. Description of Related Art

Generally, a liquid crystal display utilizes linear polarized light generated by two polarizing films to display images and the primary light source is a backlight module/the light is primarily provided by a backlight module. The backlight module generates light that travels through the first polarizing film to produce linear polarized light. Further, as the alignment of liquid crystal molecules twists in the liquid crystal display, brightness or darkness is produced after the light reaches the second polarizing film.

Since light must travel through many layers, it usually gets refracted, reflected and absorbed. As a result, the brightness of the light emitted by the liquid crystal display is less than 5%. Specifically, the absorption and the light transmittance of the polarizing films in the liquid crystal display constitute one of the major factors that affect the brightness of the liquid crystal display. Therefore, one of the major focus areas in improving liquid crystal displays is to enhance the light source intensity and the light transmittance of the polarizing films.

Currently, there are two ways to improve the overall light transmittance of a liquid crystal display, including increasing the feed-through effect of the incident light and increasing the number of backlight module light sources. Herein, the first method primarily increases the transmittance of the polarizing films or changes the polarization of the incident light before the incident light enters the polarizing film to make the polarization of the incident light and the polarization of the polarizing film parallel to each other in order to increase the transmittance of the incident light.

In other words, changing the polarization of the incident light increases the light transmittance by making the polarization of the incident light and the polarization of the polarizing film parallel to each other. Presently, one way to change the polarization of the incident light is to bond a brightness enhancement film such as the dual brightness enhancement film (DBEF) manufactured by 3M Corp and the cholesteric liquid crystal (CLC).

The optical devices of CLC works on a principle based on the separable characteristics of left-handed circularly polarized light and right-handed circularly polarized light to separate the right-handed circularly polarized light from the incident, unpolarized white light. Herein, the circularly polarized light having an opposite polarization passes through, and the circularly polarized light having the same polarization gets reflected. When the circularly polarized light having the same polarization gets reflected the second time, the circularly polarized light can pass through/get transmitted. Hence, light transmittance is increased. When used in combination with a ¼ wavelength retardation film (a.k.a. “λ/4 film”), the transmitted circularly polarized light is converted to a linear polarized light and gets transmitted/enters the polarizing film. Ultimately, the polarization of the light emitted is entirely converted to the polarization that can pass through the polarizing film to achieve brightness enhancement.

Nevertheless, currently, the bonding of a polarizer to CLC and a λ/4 film relies on a rotating layer or 45 degree bonding, which are both considered as complicated and time-consuming fabrication processes. On the other hand, a reflective polarizing film formed by CLC and a λ/4 film usually fails to provide the desired optical result and display the effects of the λ/4 film. Hence, it has been a problem that needs to be resolved.

### SUMMARY OF THE INVENTION

The present invention is directed to a method for fabricating a reflective polarizing film adapted for simplifying the conventional external paste fabrication process and overcome the shortcomings such as undesired optical results caused by more disordered alignment in the upper layer of CLC than that in the lower layer of CLC and failure to display the effects of a λ/4 film.

The present invention is directed to a reflective polarizing film adapted for substantially reducing the thickness of the reflective polarizing film.

The present invention is directed to a method for fabricating a reflective polarizing film adapted for simplifying the fabrication process for assembling a polarizing film, CLC and a phase retardation film.

The present invention is directed to a method for fabricating a reflective polarizing film that includes the following steps. First, a substrate is provided. Next, a phase retardation film is formed at least on one side of the substrate by means of coating. Afterward, a cholesteric liquid crystal (CLC) layer is formed on the phase retardation film by means of coating.

The present invention is also directed to a reflective polarizing film which includes a substrate, a rotating layer, a polarizing film, a phase retardation film, and a CLC layer. Herein, the rotating layer is formed by an ultra-thin CLC layer having a thickness less than 1 μm. The above-mentioned phase retardation film and the above-mentioned polarizing film are respectively disposed above and below the rotating layer. The CLC layer is disposed on the phase retardation film. The substrate may be disposed between the phase retardation film and the rotating layer or below the polarizing film.

The present invention is also directed to a method for fabricating the above-mentioned reflective polarizing film that includes forming a rotating layer, a polarizing film, a phase retardation film and a CLC layer by a coating technique. Further, the phase retardation film is formed prior to the formation of the CLC layer.

Since the present invention utilizes different alignments and coatings of liquid crystal materials to perform coating of a phase retardation film such as λ/4 film and coating of CLC orderly. As a result, the problems with the more disordered alignment in the upper layer of CLC compared to that in the lower layer of CLC can be solved that poor optical performance and failure to show phase retardation caused by unidirectional alignment transferring into radial alignment within the phase retardation film. Further, the present invention utilizes CLC that is non-reflective and within the range of visible light to form an ultra-thin rotating layer having a thickness of less than 1 μm. Additionally, the phase retardation film is formed before the formation of the CLC layer. Afterward, a coating process is performed to greatly reduce the complexity/difficulty of the fabrication process for a reflective polarizing film and reduce the thickness of the reflective polarizing film.

In order to make the aforementioned and other objects, features and advantages of the present invention more comprehensible, preferred embodiments accompanied with figures are described in detail below.

### BRIEF DESCRIPTION OF THE DRAWINGS

FIG.1 illustrates a method for fabricating a reflective polarizing film according to the first embodiment of the present invention.

FIG.2A and FIG.2B respectively are schematic cross-sectional views illustrating two reflective polarizing films according to the second embodiment of the present invention.

FIG.3A and FIG.3B respectively illustrate two methods for fabricating two reflective polarizing films according to the third embodiment of the present invention.

### DESCRIPTION OF EMBODIMENTS

The present invention is described more fully hereinafter with reference to the accompanying drawings, in which embodiments of the invention are shown. This invention, however, may be embodied in many different forms and should not be construed as limited to the embodiments set forth herein. The following embodiments are provided to thoroughly and completely disclose the present invention and fully convey the scope of the present invention to those skilled in the art. In the drawings, in order to apparently indicate the sizes of each layer and region, the layers and regions are magnified and not sized.

In the following description, space relative terms such as “below”, “above”, “between”, and the like are used to describe the relation between a layer or a feature and another layer (or another number) or another feature. It should be noted that the aforementioned space relative terms are used to describe devices in use or in operation and also devices in an orientation that is different from what is shown in the drawings. For example, if the devices shown in the drawings are rotated, then a layer (or a device) that was originally described to be “below” or “under” another layer (or another device) is re-oriented to be “above” the other layer (or the other device). In other words, the so-called “below” can refer to two orientations: both “above” and “below”.

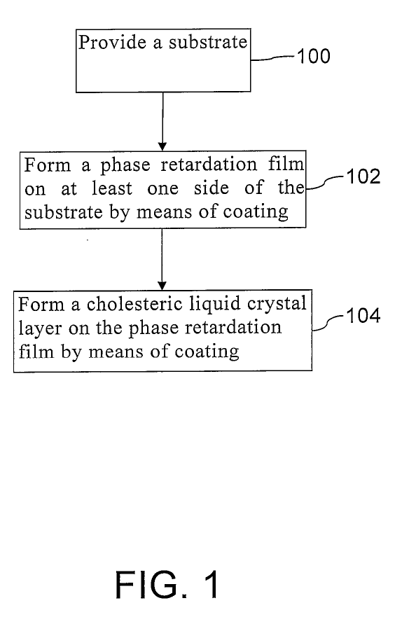

FIG. 1 schematically illustrates a method for fabricating a reflective polarizing film according to the first embodiment of the present invention.

Please refer to FIG. 1. In step 100, a substrate is provided. Further, the substrate may be a transparent substrate or an opaque substrate. When the first embodiment is applied in a display cell, the substrate may be a panel glass or at least one of the following: a thin film transistor, a color filter and an alignment layer is formed on the substrate to facilitate a direct or an indirect formation of an optical film on each of the aforementioned devices.

Next, in step 102, a coating technique is used to form a phase retardation film on at least one side of the substrate. Herein, the coating technique is, for example, a spin coating, a slot-die coating, an extrusion coating, a Mayer rod coating or a blade coating. Further, the coating process may be a roll-to-roll process. In addition, the aforementioned phase retardation film is, for example, a λ/4 film and the method used for fabricating the λ/4 film includes, for example, coating the substrate with liquid crystals having a λ/4 phase difference, and then performing a curing process using an ultraviolet light.

Thereafter, in step 104, a cholesteric liquid crystal (CLC) layer is formed on the phase retardation film by means of coating. Herein, the coating technique is, for example, a spin coating, a slot-die coating, an extrusion coating, a Mayer rod coating or a blade coating. Further, the coating process may be a roll-to-roll process. The method for forming the CLC layer includes coating the phase retardation film with a reflective thickness of CLC and curing the CLC with an ultraviolet ray. Since the thickness of the CLC layer is usually thicker than that of the phase retardation film, the steps of coating and curing CLC can be repeated if necessary to achieve the reflective thickness desired.

It should be noted that step 102 and step 104 cannot be reversed and the coating techniques used for these two steps may be the same or different.

Further, the said phase retardation film and the CLC layer may be fabricated inside or outside the display cell.

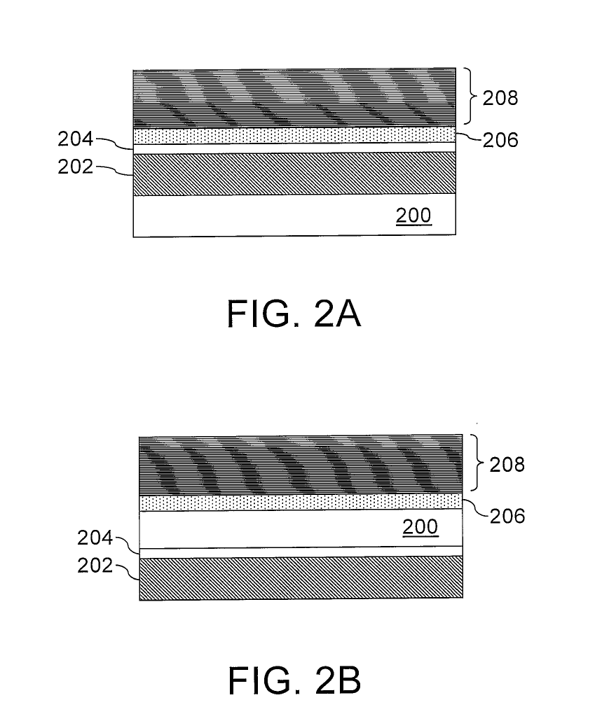

FIG.2A and FIG.2B respectively are schematic cross-sectional views illustrating two reflective polarizing films according to the second embodiment of the present invention.

Please refer to FIG. 2A and FIG. 2B. According to the second embodiment, a reflective polarizing film includes a substrate 200, a polarizing film 202, a rotating layer 204, a phase retardation film 206 and a chloesteric liquid crystal (CLC) layer 208. Herein, the rotating layer 204 is formed by an ultra-thin layer of CLC having a thickness of less than 1 μm. Further, the phase retardation film is, for example, a λ/4 film. The phase retardation film 206 and the polarizing film 202 are respectively disposed above and below the rotating layer 204. The CLC layer 208 is disposed on the phase retardation film 206. The substrate 200 may be disposed below the polarizing film 202 (as shown in FIG. 2A); or the substrate 200 may be disposed between the phase retardation film 206 and the rotating layer 204 (as shown in FIG. 2B). The substrate 200 may be a transparent substrate or an opaque substrate.

In the second embodiment, when the reflective polarizing film is applied in a display cell, the susbtarte 200 may be a panel glass or at least one of the following: a thin film transistor, a color filter and an alignment layer is formed on the substrate 200 (not shown).

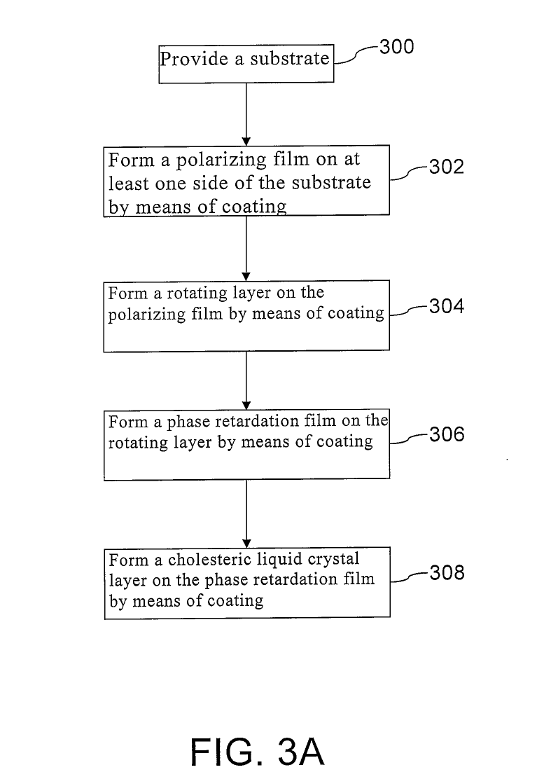

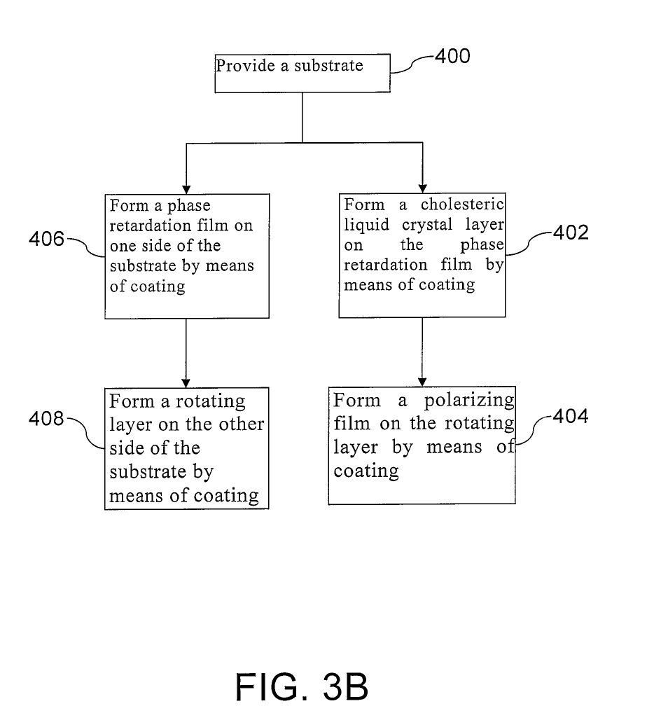

FIG. 3A and FIG. 3B respectively illustrate two methods for fabricating two reflective polarizing films according to the third embodiment of the present invention. Specifically, FIG. 3A illustrates the method for fabricating the reflective polarizing film shown in FIG. 2A and FIG. 3BA illustrates the method for fabricating the reflective polarizing film shown in FIG. 2B.

According to the third embodiment, a coating technique is used to form each layer on the substrate. Further, the phase retardation film is formed prior to the formation of the cholesteric liquid crystal (CLC) layer. Herein, according to FIG. 3A, the polarizing film is formed on the substrate (step 302), then the rotating layer is formed on the polarizing film (step 304), the phase retardation film is formed on the rotating layer (step 306), and the CLC layer is formed on the phase retardation film (step 308).

According to FIG. 3B, the phase retardation film is respectively formed on the two sides of the substrate (step 402), the rotating layer is formed on the two sides of the substrate (step 406), the CLC layer is formed on the phase retardation film (step 404), and the polarizing film is formed on the rotating layer (step 408).

Please refer to FIG. 3A and FIG. 3B. In steps 300 and 400, the substrate may be a transparent substrate or an opaque substrate. In steps 302˜308 and steps 402˜408, the coating technique is, for example, a spin coating, a slot-die coating, an extrusion coating, a Mayer rod coating or a blade coating. Further, the coating technique used in each step may be different or the same according to actual requirements. Further, the coating process may be a roll-to-roll process.

In addition, the rotating layer and the polarizing film shown in FIG. 3A and FIG. 3B may be fabricated inside or outside the display cell. Moreover, the phase retardation film and the CLC layer may also be fabricated inside or outside the display cell. The phase retardation film may be a λ/4 film.

To sum up, the present invention has the following features:

The present invention utilizes an entire coating process to fabricate a cholesteric liquid crystal layer and a phase retardation film to simplify the conventional external bond fabrication process. Further, the CLC layer is formed after the phase retardation film is coated. If the order of fabrication process is different, the alignment in the upper layer of CLC is more disordered than that in the lower layer causing undesired optical performances, and the alignment of the phase retardation film is not unidirectional, but radial resulting in failure to display the compensation effects.

The present invention forms an additional rotating layer on the polarizing film by performing a spin coating process to rotate optical axis of the polarizer film at a 45 degree angle with respect to the alignment axis. Further, the rotating layer is formed by an ultra-thin layer of non-reflective CLC having a thickness of less than 1 μm. Since the CLC within the range of the visible light is non-reflective, the polarizing film is rotated to 45° by utilizing the twisting alignment of the liquid crystals.

The rotating layer and the polarizing film of the present invention may also be fabricated by an entire coating process to simplify the conventional external bond fabrication process.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for fabricating a reflective optical film, comprising:
providing a substrate;
forming a phase retardation film on at least one side of the substrate by means of coating; and
forming a cholestric liquid crystal (CLC) layer on the phase retardation film by means of coating.

2. The method of claim 1, wherein a coating technique is selected from one of the following: a spin coating, a slot-die coating, an extrusion coating, a Mayer rod coating, and a blade coating.

3. The method of claim 2, the coating technique comprises a roll-to-roll process.

4. The method of claim 1, wherein the substrate is a transparent substrate or an opaque substrate.

5. The method of claim 1, wherein the phase retardation film comprises a λ/4 film.

6. The method of claim 1, wherein the phase retardation film and the CLC layer are fabricated inside or outside a display cell.

7. A reflective polarizing film, comprising:
a rotating layer formed by an ultra-thin layer of cholesteric liquid crystal (CLC) having a thickness less than 1 μm;
a phase retardation film disposed on the rotating layer;
a polarizing film disposed below the rotating layer;
a cholesteric liquid crystal layer (CLC) disposed on the phase retardation film; and
a substrate disposed between the phase retardation film and the rotating layer or below the polarizing film.

8. The reflective polarizing film of claim 7, wherein the substrate is a transparent substrate or an opaque substrate.

9. The reflective polarizing film of claim 7, wherein the substrate comprises a panel glass.

10. The reflective polarizing film of claim 7, wherein the substrate further comprises a thin film transistor.

11. The reflective polarizing film of claim 7, wherein the substrate further comprises a color filter.

12. The reflective polarizing film of claim 7, wherein the substrate further comprises an alignment layer.

13. The reflective polarizing film of claim 7, wherein the phase retardation film comprises a λ/4 film.

14. A method for fabricating the reflective polarizing film of claim 7, characterizing in that:
forming a rotating layer, a polarizing film, a phase retardation film, and a CLC layer by means of coating; and
forming a phase retardation film prior to the formation of a CLC layer.

15. The method of claim 14, wherein a coating technique is selected from one of the following: a spin coating, a slot-die coating, an extrusion coating, a Mayer rod coating, and a blade coating.

16. The method of claim 15, wherein the coating technique comprises a roll-to-roll process.

17. The method of claim 14, wherein the phase retardation film and the CLC layer are fabricated inside or outside a display cell.

18. The method of claim 14, wherein the phase retardation film and the CLC layer are fabricated inside or outside a display cell.

19. The method of claim 14, wherein the substrate is a transparent substrate or an opaque substrate.

20. The method of claim 14, wherein the phase retardation film comprises a λ/4 film.
